(19) United States
(12) Patent Application Publication
(10) Pub. No.: US 2003/0232540 A1
(43) Pub. Date: Dec. 18, 2003

(54) Rapid lamp assembly for high energy lamps

(75) Inventors: Juergen Nick, Mount Pleasant, SC (US); Peter Schwarz-Kiene, Nurtingen (DE)

Correspondence Address: SCHNADER HARRISON SEGAL & LEWIS, LLP, 1600 MARKET STREET, SUITE 3600, PHILADELPHIA, PA, 19103

(73) Assignee: Ozonia North America, Inc., Elmwood Park, NJ (US)

(21) Appl. No.: 10/172,669

(22) Filed: Jun. 14, 2002

(51) Int. Cl. H01K 1/00

(52) U.S. Cl. 439/617

(57) ABSTRACT

The invention is directed to a lamp assembly for a high energy lamp to be placed within a reactor vessel that includes an electrical connector removably engaged to the power coupler for receiving the electrical power from a power coupler in electrical contact with a power supply for transferring electrical power to the lamp assembly; a radiation shield contacting the electrical connector, the radiation shield substantially shielding the electrical connector from the high energy lamp; and a lamp support contacting the electrical connector to receive the electrical power therefrom for providing the electrical power to the high energy lamp. The lamp assembly may include a plurality of lamps and lamp assemblies, and may include a plurality of reactor glands for mounting the lamp assemblies to the reactor vessel. The electrical connector may take a variety of forms, such as prongs, snaps, threaded contacts, and spring contacts.

### BACKGROUND OF THE INVENTION

1. Field of the Invention

This invention is related to an electrical connector and radiation shield assembly for a high energy lamp. Particularly, the invention is related to a rapid lamp assembly having removably engagable electrical connectors and an integrated radiation shield.

2. Description of the Prior Art

High energy lamp arrays are used in a number of applications, such as the use of ultraviolet lamps for ozone generation, wastewater treatment, and disinfection. In these systems, an array of high energy ultraviolet lamps are grouped together in a reactor vessel through which a fluid (e.g., drinking or wastewater in the case of disinfection) is passed. Unlike other lamp systems, these high energy lamp arrays produce a significant amount of heat and electromagnetic radiation across the ultraviolet portion of the spectrum. For example, temperatures in these lamp assemblies can exceed 1000° C.

Typically, each lamp is individually mounted in the array using a lamp assembly, and power is supplied to each lamp assembly by wiring (such as by soldering or otherwise fastening) the electrical conductors to the electrical connectors within the lamp assembly. In order to inspect or replace a lamp, these connectors must be detached and removed, and reconnected once the lamp is replaced.

These conventional high energy ultraviolet lamp systems have the significant disadvantage, however, that the tremendous radiation emitted by the ultraviolet lamps quickly degrades the electrical lamp connectors. For example, the various wavelengths emitted by the ultraviolet lamps heat the electrical connections to the lamps, thereby reducing the conductivity of the lamp connector, and, in addition, the electrical connector is corroded by the presence of ozone produced by the ultraviolet lamp in specific portions of the electromagnetic spectrum. Moreover, the maintenance of the lamp assembly is time consuming and expensive, due to the need to re-connect each electrical connection every time a lamp must be removed and replaced.

Accordingly, a system is needed that allows for the rapid assembly of the ultraviolet lamps, while also adequately protecting the electrical connectors against the heat emitted by the lamps and from corrosion created from the presence of ozone.

### SUMMARY OF THE INVENTION

The invention is directed to a lamp assembly for a high energy lamp to be placed within a reactor vessel that includes an electrical connector removably engaged to the power coupler for receiving the electrical power from a power coupler in electrical contact with a power supply for transferring electrical power to the lamp assembly; a radiation shield contacting the electrical connector, the radiation shield substantially shielding the electrical connector from the high energy lamp; and a lamp support contacting the electrical connector to receive the electrical power therefrom for providing the electrical power to the high energy lamp. The lamp assembly may include a plurality of lamps and lamp assemblies, and may include a plurality of reactor glands for mounting the lamp assemblies to the reactor vessel. The electrical connector may take a variety of forms, such as prongs, snaps, threaded contacts, and spring contacts.

### BRIEF DESCRIPTION OF THE DRAWINGS

FIGS. 1(a)-(c) are diagrams illustrating a preferred embodiment of a high energy lamp assembly in a reactor vessel in accordance with aspects of the invention.

FIGS. 2(a)-(c) are diagrams illustrating another preferred embodiment of a high energy lamp assembly in a reactor vessel in accordance with aspects of the invention.

### DETAILED DESCRIPTION

The present invention will be understood more fully from the detailed description given below and from the accompanying drawings of preferred embodiments of the invention; which, however, should not be taken to limit the invention to a specific embodiment but are for explanation and understanding only.

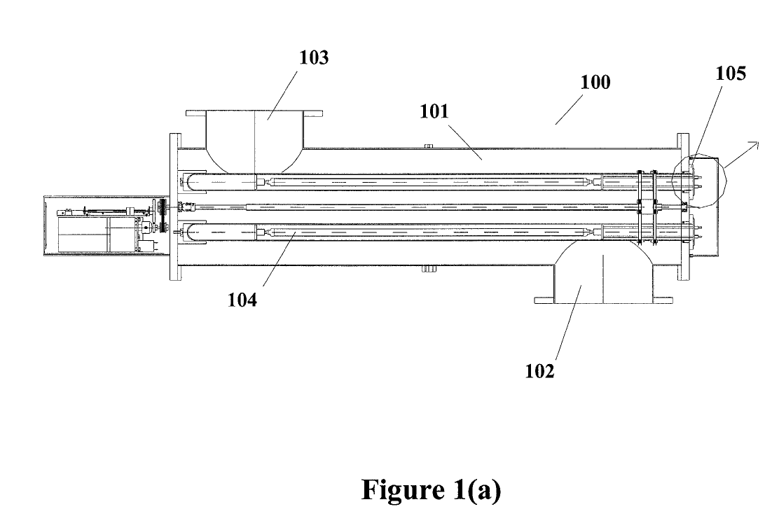

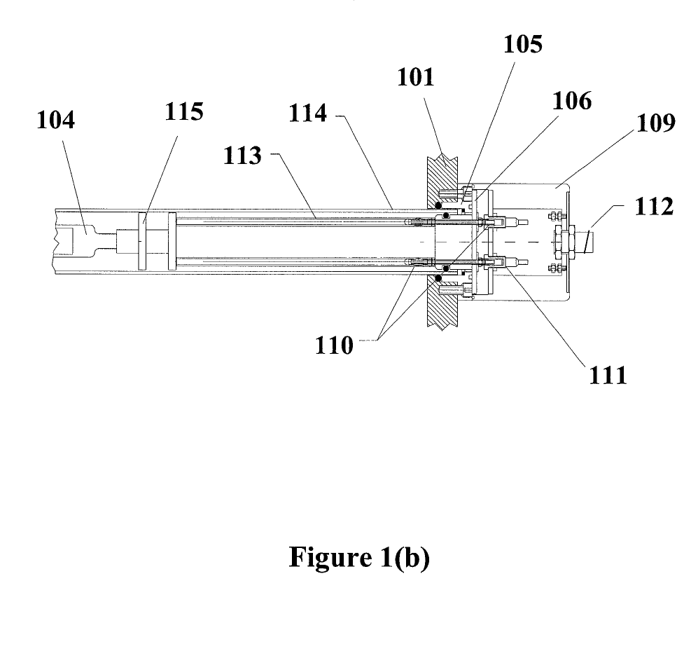

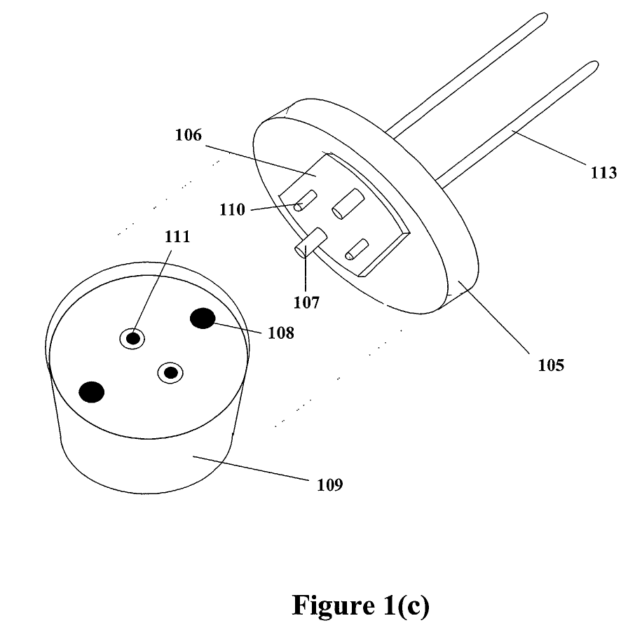

FIG. 1(a) illustrates one preferred embodiment of a high energy lamp array in a reactor vessel in accordance with aspects of the invention. As shown in FIG. 1(a), the high energy ultraviolet reactor system 100 generally includes a reactor vessel 101, having inlet port 102 and outlet port 103, into which a plurality of ultraviolet lamps 104 are inserted. Those of ordinary skill in the art will appreciate that while the preferred embodiment of the invention is used in connection with the lamp assembly of a multiple lamp array, it may also be used in connection with a single ultraviolet lamp.

Ultraviolet lamps 104 are secured with reactor vessel 101 by reactor glands 105, and power is supplied to lamps 104 through reactor glands 105 by a removable power head coupler. This is illustrated in more detail in FIG. 1(b), which is an exploded drawing of the rapid lamp assembly system of the invention shown in FIG. 1(a). A simplified drawing of the rapid lamp assembly and power coupler is also shown disengaged in FIG. 1(c).

As shown in FIGS. 1(b) and 1(c), reactor gland 105 has a lamp connector plate 106 removably affixed thereto. Standoffs 107 are preferably mounted to lamp connector plate 106, and are capable of removably engaging standoff ports 108 on power coupler head 109 to provide strengthening support for power head coupler 109 while it is affixed to reactor gland 105. Similarly, electrical connector prongs 110 are affixed to lamp connector plate 106, and are capable of removably engaging electrical connector ports 111 on power coupler head 109. Electrical connector ports 111 are, in turn, electrically connected to a power supply (not shown) via power coupler head 109 in a conventional manner, such as by bolted or soldered wire connections through cable gland 112 and the like.

Positioning tubes 113 are also preferably included for positioning lamps 104 within the quartz protection tubes 114 of reactor vessel 101 and supplying electrical power thereto. Accordingly, positioning tubes 113 are electrically connected to electrical connector prongs 110 in a conventional manner. For example, positioning tubes 113 are capable of preferably removably engaging electrical connector prongs 110, which extend through lamp connector plate 106, to be in electrical contact therewith. Positioning tubes 113 are conventionally sized in accordance with the size of lamp 104 and reactor vessel 101 to provide proper support thereto. Lamps 104 are then plugged into positioning tubes 113 to receive electrical power therefrom.

Positioning tubes 113, electrical connector prongs 110, and electrical connector ports 111 may comprise any material capable of adequately conducting electricity to lamp 104, such as metals or metal alloys, and is not particularly limited. Electrical connector prongs 110 are preferably, but not necessarily, gold plated. Positioning tube 113 may also be coated with an anticorrosive material, such as Teflon® and the like.

Radiation shield 115 may be formed as an integral part of lamp 104, or may simply be mounted atop positioning tubes 113 within quartz protection tube 114 and minimizes the exposure of the electrical connections to heat and to ozone produced by the high energy radiation of the lamps. Radiation shield 115 preferably comprises a ceramic material, but may comprise any other equivalent material that is capable as acting as a radiation shield to the heat and ozone produced by lamp 104. Lamp connector plate 106 may be affixed to reactor gland 103 using any number of conventional means, but is preferably removably connected thereto through the use of bolts, pins, or the like.

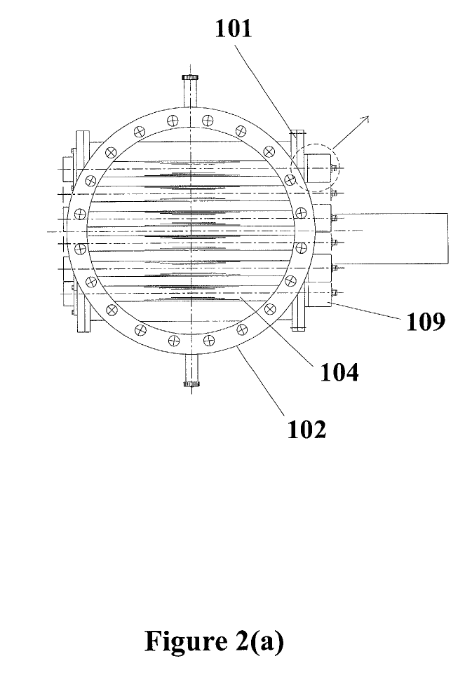

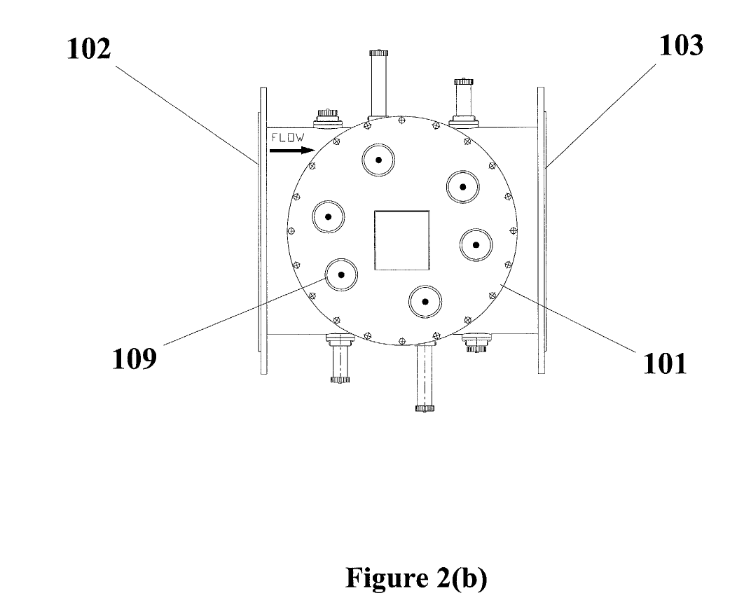

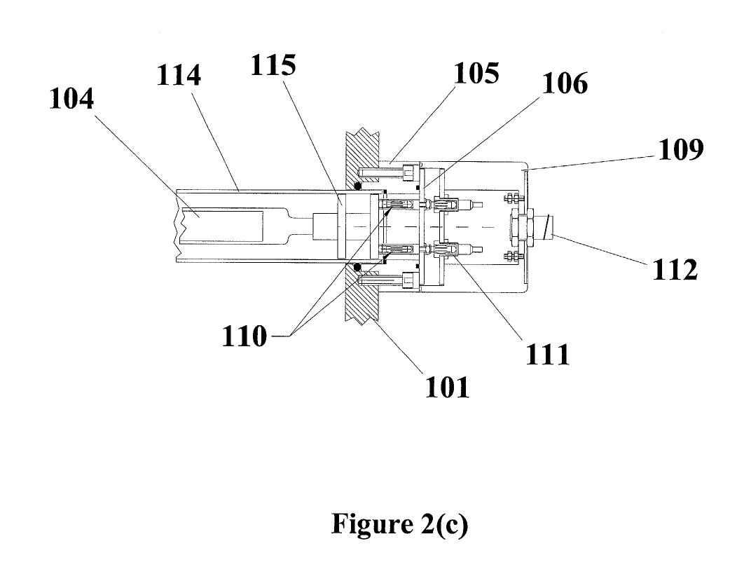

An alternative preferred embodiment of the invention is shown in FIGS. 2(a)-(c), which illustrate an in-line high energy ultraviolet disinfection system in accordance with the invention. As shown in FIGS. 2(a)-(c), positioning tubes 113 are not necessary in an inline system, since the lamps are positioned directly perpendicular to the fluid flow.

By providing the rapid lamp assembly discussed above, the invention provides significant advantages over the prior art in that it allows for the quick removal of the ultraviolet lamps from the reactor vessel for inspection, replacement, or removal, without the need to hard wire each lamp to a power supply. It also minimizes the exposure of the electrical connectors to heat and ozone produced by the lamps.

Although this invention has been described with reference to particular embodiments, it will be appreciated that many variations may be resorted to without departing from the spirit and scope of this invention as set forth in the appended claims. For example, while the electrical connector has been shown as a plurality of prongs inserted into the power coupler, the invention is not limited thereto, and the electrical connector and power coupler may be any type of device that is capable of being removably engaged yet providing electrical power when in contact, such as snaps, threaded contacts, spring contacts, etc. Similarly, while the power coupler has been shown as being hard-wired to the power supply, it may be removably engaged therefrom using the same type of contacting devices.

What is claimed is:

1. A lamp assembly for a high energy lamp to be placed within a reactor vessel comprising:
an electrical connector removably engage to a power coupler for receiving electrical power therefrom;
a radiation shield contacting said electrical connector, said radiation shield substantially shielding said electrical connector from said high energy lamp; and
a lamp support contacting said electrical connector to receive said electrical power therefrom for providing said electrical power to said high energy lamp.

2. The lamp assembly of claim 1, further comprising a reactor gland contacting said radiation shield for mounting said lamp assembly to said reactor vessel.

3. The lamp assembly of claim 1, wherein said power coupler is removably engaged to an electrical conductor connected to said power supply.

4. The lamp assembly of claim 1, wherein said electrical connector comprises one or more selected from the group consisting of prongs, snaps, threaded contacts, and spring contacts.

5. The lamp assembly of claim 1, wherein said radiation shield comprises a ceramic material.

6. The lamp assembly of claim 1, wherein said lamp support further comprises a plurality of lamp positioning tubes.

7. The lamp assembly of claim 1, wherein said high energy lamp is an ultraviolet lamp capable of heating said lamp assembly to at least 1000° C.

8. The lamp assembly of claim 1, wherein said electrical connector is gold plated.

9. A high energy lamp array reactor system comprising:
a plurality of lamp assemblies, each comprising:
a power coupler in electrical contact with a power supply for transferring electrical power to said lamp assembly;
an electrical connector removably engaged to said power coupler for receiving said electrical power therefrom;
a radiation shield contacting said electrical connector, said radiation shield substantially shielding said electrical connector from said high energy lamp; and
a lamp support contacting said electrical connector to receive said electrical power therefrom for providing said electrical power to said high energy lamp;
a reactor vessel having a plurality of openings therein; and
a plurality of reactor glands for removably engaging said plurality of lamp assemblies to said reactor vessel.

10. The high energy lamp array of claim 9, wherein said power coupler is removably engaged to an electrical conductor connected to said power supply.

11. The high energy lamp array of claim 9, wherein said electrical connector comprises one or more selected from the group consisting of prongs, snaps, threaded contacts, and spring contacts.

12. The high energy lamp array of claim 9, wherein said radiation shield comprises a ceramic material.

13. The high energy lamp array of claim 9, wherein said lamp support further comprises a plurality of lamp positioning tubes.

14. The lamp assembly of claim 1, wherein said high energy lamp is an ultraviolet lamp capable of heating said lamp assembly to at least 1000° C.

15. The lamp assembly of claim 1, wherein said electrical connector is gold plated.

16. A high energy ultraviolet lamp array reactor system comprising:
a plurality of lamp assemblies, each comprising:
a power coupler in electrical contact with a power supply for transferring electrical power to said lamp assembly;
a plurality of electrical connectors removably engaged to said power coupler for receiving said electrical power therefrom;
a radiation shield contacting said electrical connectors, said radiation shield substantially shielding said electrical connectors from said high energy lamp; and
a plurality of lamp supports contacting said electrical connector to receive said electrical power therefrom for providing said electrical power to said high energy ultraviolet lamp;
a reactor vessel having a plurality of openings therein; and
a plurality of reactor glands for removably engaging said plurality of lamp assemblies to said reactor vessel.

17. The high energy ultraviolet lamp array of claim 16, wherein said electrical connector comprises one or more selected from the group consisting of prongs, snaps, threaded contacts, and spring contacts.

18. The high energy ultraviolet lamp array of claim 16, wherein said radiation shield comprises a ceramic material.

19. The high energy ultraviolet lamp array of claim 16, wherein said lamp support further comprises a plurality of lamp positioning tubes.

20. The high energy ultraviolet lamp array of claim 16, further comprising a plurality of standoffs contacting said radiation shield and said power coupler for providing support thereto.
